(19) United States
(12) Patent Application Publication
(10) Pub. No.: US 2025/0179906 A1
(43) Pub. Date: Jun. 5, 2025

(54) SYSTEMS AND METHODS FOR THE DETECTION OF KEY SEATING WEAR IN OFFSHORE DRILLING

(71) Applicant: Kongsberg Maritime AS, Kongsberg (NO)

(72) Inventors: Massimiliano RUSSO, Katy, TX (US); Lasse Eskil EILERTSEN, Drammen (NO); Rune HAAKONSEN, Houston, TX (US); Tomas CANNY, Asheville, NC (US); Jon Erling REFSNES, Oslo (NO)

(21) Appl. No.: 18/526,655

(22) Filed: Dec. 1, 2023

(51) Int. Cl. E21B 12/02; E21B 7/128

(52) U.S. Cl. CPC E21B 47/007; E21B 7/128; G01H 1/003; G01M 13/00

(57) ABSTRACT

Systems and methods of detecting key seating wear during drilling operations include a sensor for detecting vibrations in underwater drilling structures and a controller connected to the sensor. The controller processes the data from the sensor to determine if key seating wear is occurring. There may also be a signal injector connected to the controller that is used to inject a signal into the underwater drilling structures. This signal can also be detected by the sensor for use by the controller in determining if key seating wear is present.

### BACKGROUND

This disclosure relates to the field of offshore drilling technology. Specifically, this disclosure is related to the detection of key seating wear to prevent key seating in offshore drilling, which is the result of unintentional wear caused by contact between a drill pipe and the inner diameter of a marine drilling riser and/or the inner diameter of the subsea well production casing.

Offshore drilling is the general term for drilling operations that involve drilling a wellbore in the seabed. This process takes place in waters of varying depths. A drilling platform is maintained on the surface of the water, with a drilling riser extending from the drill platform to a wellhead that is fixed to the seabed below the surface. The drilling riser is a hollow structure that contains the drill pipe, which is the rotating element that drives the drill bit that forms the well in the seabed. The drill pipe is driven by machinery on the drilling platform.

There are generally two types of drilling platforms: (1) fixed or founded platforms that are fixed to the seabed, and (2) floating platforms that are not fixed to the seabed. Floating platforms can be anchored to the seabed in shallower waters, but they are more generally used in deeper water situations where fixing the drilling platform to the seabed is not feasible. In these situations the drilling platform is maintained at a setpoint by dynamic positioning, which uses the engines and thrusters of the drilling platform to hold the drilling platform in the desired position on the surface.

Ideally, the drilling platform is positioned at an optimum setpoint to keep the drilling riser as vertical as possible. This ensures that the drill pipe that is carried within the riser does not contact the inner walls of the drilling riser. In reality, several factors can act to push the drilling platform, and/or drilling riser, out of alignment with the fixed wellhead, including sea conditions, wind, and underwater currents. When this happens, the drilling riser will flex into a curve. This curvature can, in turn, bring the drilling pipe, which is passed through the drilling riser, into contact with the inner walls of the riser and/or parts of the subsea well structure. This contact and rotation of the drill pipe can result in accelerated wear of the drilling riser and other components connected to the riser. This phenomenon is called key seating, and can result in damage to the drilling riser/subsea well equipment and, ultimately, equipment or drill pipe failure. This problem is significant because repairing a drilling riser/subsea well structure at a deep water drilling project can require a multi-week stop in drilling operations at very substantial costs. Ideally, key seating wear can be detected as it initially occurs and drilling operations can be paused until the drilling platform is realigned.

Some drilling platforms include sensors that can determine the amount of misalignment that the drilling riser has with respect to the wellhead. This is typically expressed as an angle of the riser with respect to the fixed wellhead. However, this misalignment is only partially helpful in avoiding key seating because the relationship between the misalignment angle and the onset of key seating can vary depending on the parameters of the drilling operation. For example, in one drilling operation, key seating may not occur until the misalignment angle exceeds two degrees. In other drilling operations, the key seating may occur at angles below one degree. There is no certain way to predict what angle will result in key seating in advance with any accuracy. This uncertainty makes it difficult to address key seating concerns by stopping drilling operations based on the misalignment angle.

Some drilling platforms are also able to sample the lubricating fluid, or mud, that is passed through the drilling riser to determine if there are any metal particles present. These particles may indicate the presence of key seating. However, because continuous sampling is logistically challenging on an offshore drilling platform, and the presence of metal particles indicates that key seating has already occurred, which makes this technique reactive instead of preemptive.

Therefore, there is a need for systems and methods of detecting and addressing key seating as it occurs in drilling operations. Preferably, the system will be adaptable to various drilling operations and will not require substantial reworking of existing drilling infrastructure.

### BRIEF SUMMARY

In an embodiment, a system for detecting key seating wear during drilling operations includes a sensor configured to detect vibrations in an underwater drilling structure and a controller operably connected to the sensor, the controller configured to receive data from the sensor and to process the data to detect key seating.

In an embodiment, a method for detecting key seating wear in drilling operations includes recording vibration data in an underwater structure during drilling operations using a sensor disposed on the underwater structure, and processing the vibration data from the sensor at a controller operably connected to the sensors to detect key seating by filtering the data to detect an anomaly that corresponds to key seating.

In a further embodiment, the sensor is one of a plurality of sensors, each of the plurality of sensors being configured to detect vibrations in an underwater drilling structure and operably connected to the controller.

In a further embodiment, the controller is configured to send an alert to a user when key seating wear is detected.

In a further embodiment, the system further includes a display operably connected to the controller, the controller being configured to use the display to alert the user to key seating wear.

In a further embodiment the controller is configured to use the sensor to record a baseline data set when key seating wear is not present.

In a further embodiment the controller is configured to use the baseline data to determine if key seating wear is detected.

In a further embodiment the underwater drilling structure is selected from the group consisting of a drilling riser and a lower marine riser package.

In a further embodiment the system includes a signal injector controlled by the controller and configured to transmit a vibrational signal into a drill pipe.

In a further embodiment the controller is configured to detect the vibrational signal using the sensor to detect key seating wear.

In a further embodiment the controller is configured to determine a position of the key seating by comparing the time of injection of the signal with the time of detection of the signal by the sensor.

In an embodiment, an offshore drilling system, includes a drill platform; and any of the systems for detecting key seating wear described above.

In an embodiment, a method for detecting key seating wear in drilling operations, includes recording vibration data in an underwater structure during drilling operations using a sensor disposed on the underwater structure; and processing the vibration data from the sensor at a controller operably connected to the sensors to detect key seating wear by filtering the data to detect an anomaly that corresponds to key seating wear.

In a further embodiment, recording vibration data further includes receiving data from a plurality of sensors, each of the plurality of sensors being configured to detect vibrations in an underwater drilling structure and operably connected to the controller.

In a further embodiment the method includes using a display operably connected to the controller to alert a user to key seating wear.

In a further embodiment the method includes using the sensor to record a baseline data set when key seating wear is not present.

In a further embodiment, the method includes using the baseline data as part of the processing the vibration data to determine if key seating wear is detected.

In a further embodiment, the method includes using a signal injector controlled by the controller to inject a vibrational signal into a drill pipe.

In a further embodiment, the method includes detecting the vibrational signal using the sensor.

In a further embodiment the method includes determining a position of the key seating wear by comparing the detected vibrational signal to the signal injected by the signal injector.

In an embodiment, a key seating wear detector for offshore drilling, including a sensor configured to detect vibrations in an underwater drilling structure, a controller disposed on a drill platform and operably connected to the sensor, the controller configured to receive data from the sensor and to process the data to detect key seating, and an alert device operably connected to the controller, the controller being configured to use the alert device to alert a user to key seating wear.

In a further embodiment, the alert device comprises a display

Certain aspects of the disclosure have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS/FIGURES

The accompanying drawings, which are incorporated herein and form a part of the specification, illustrate the present disclosure and, together with the description, further serve to explain the principles thereof and to enable a person skilled in the pertinent art to make and use the same.

FIG. 1 is a schematic diagram of an offshore drilling system according to an embodiment.

FIG. 2 is a schematic of a portion of an offshore drilling system adjacent a seabed according to an embodiment.

FIG. 3 is cross section view of drilling riser and drill pipe in a first configuration according to an embodiment.

FIG. 4 is a graph of data received by a sensor according to an embodiment.

FIG. 5 is a schematic of a portion of an offshore drilling system adjacent a seabed according to an embodiment.

FIG. 6 is a cross section view of a drilling riser and drill pipe in a second configuration according to an embodiment.

FIG. 7 is a graph of data received by a sensor according to an embodiment.

FIG. 8 is a system diagram of a key seating wear detection system according to an embodiment.

In the drawings, like reference numbers generally indicate identical or similar elements. Additionally, generally, the left-most digit(s) of a reference number identifies the drawing in which the reference number first appears.

### DETAILED DESCRIPTION

Reference will now be made in detail to representative embodiments illustrated in the accompanying drawings. References to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such a feature, structure, or characteristic in connection with other embodiments whether or not explicitly described.

Systems and methods of the present disclosure address the issue of key seating wear detection, at least in part by using sensors to detect vibration or acoustic frequencies in the drilling riser and related equipment. The detected signals are processed and anomalies representing key seating wear can be identified in real time, allowing drilling operations to be paused immediately. In some embodiments, the position of the key seating contact along the drilling riser or well can also be determined. These systems and methods have several advantages, including allowing for immediate and accurate detection of key seating wear, while allowing for drilling operations to be continued until and unless key seating wear is detected. This improves uptime of drilling operations, and also substantially reduces the risks of damage caused by key seating on drilling equipment.

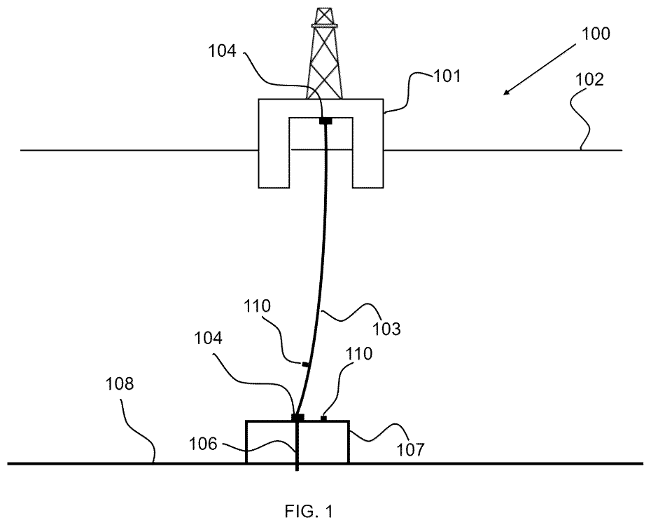

As shown in FIG. 1, a drilling system 100 includes a drill platform 101 located on the surface of the water 102. Drill platform 101 can be any type of water-based drilling platform. However, a skilled artisan would understand that so-called floating type drill platform 101 are generally more susceptible to key seating issues. Drill platform 101 functions to provide the platform for all drilling operations.

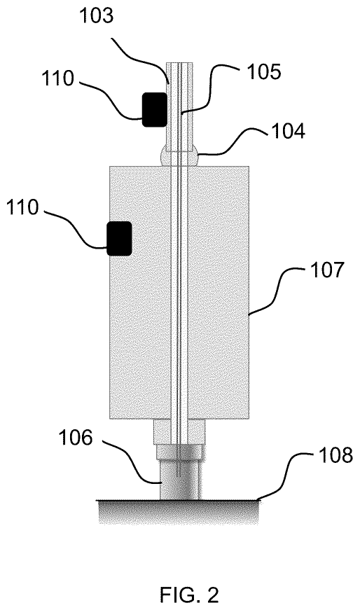

Extending into water 102 from the bottom of drill platform 101 is a drilling riser 103. Drilling riser 103 is a hollow structure, typically formed as a tube, that contains a drill pipe 105 (see FIGS. 2, 3, 5, and 6). Drill pipe 105 is the element that is rotated by suitable machinery on drill platform 101 to provide the rotational power to the drill bit (not shown) that creates the well.

Drilling riser 103 extends towards the seabed 108 where it meets with a blowout preventer stack (“BOP stack”) 107 that is connected above wellhead 106. These elements are fixed to seabed 108 and are the surface end of the well. BOP stack 107 can include all suitable equipment for interfacing with the end of wellhead 106, including valves, fittings, and blowout preventers. Present at the interface between drilling riser 103 and BOP stack 107 is a flex joint 104. Flex joint 104 accommodates misalignment between drilling riser 103 and drill pipe 105 and wellhead 106. As seen in FIG. 1, there may also be a flex joint 104 at drill platform 101 to perform a similar function.

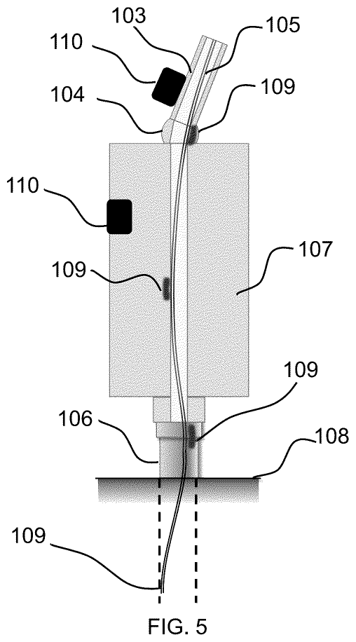

FIG. 1 demonstrates a floating drill platform 101 that is not anchored or fixed to seabed 108. As seen in FIG. 1, drill platform 101 is not directly above wellhead 106. Instead, drill platform 101 is offset to the right in FIG. 1, which creates the curve seen in drilling riser 103 that results in the angular misalignment of drill pipe 105 discussed in the background with elements such as flex joint 104. FIG. 5 shows a schematic of the elements of drilling system 100 adjacent seabed 108 during such a misaligned state. Contrast FIG. 5 with FIG. 2, which shows the elements of drilling system 100 adjacent seabed 108 when there is alignment. The type of misalignment shown in FIGS. 1 and 5 can result in key seating wear.

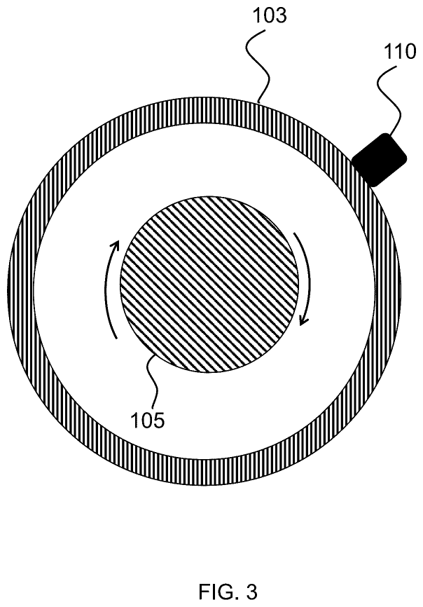

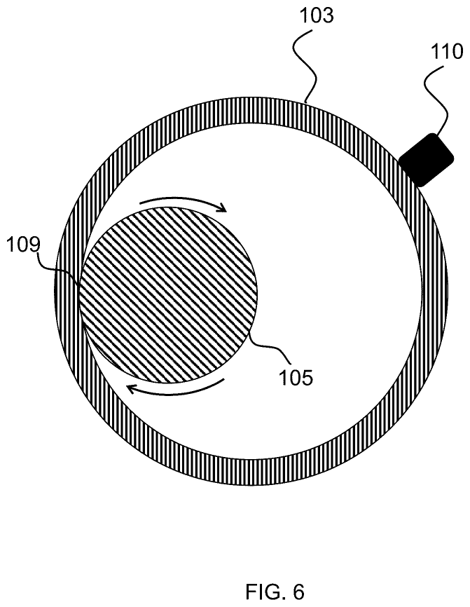

FIGS. 3 and 6 are cross-sections of drilling riser 103 that show drill pipe 105. Drill pipe 105 rotates within drilling riser 103 to provide rotational torque to the drill bit in wellhead 106. Also present but not shown in FIGS. 3 and 6 is heavy fluid that is circulated inside riser 103. This heavy fluid, often called mud, is used to maintain the proper pressure balance inside the well, provide sufficient lubrication, cooling, and debris removal for drilling operations.

FIG. 3 corresponds to FIG. 2 and shows drilling riser 103 in a normal operating mode where no key seating is occurring because drill platform 101 is aligned with wellhead 106. As shown, drill pipe 105 is not in contact with the inner wall of drilling riser 103.

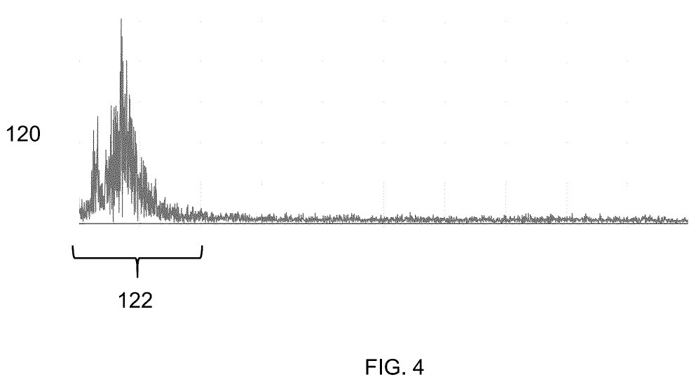

FIG. 5 corresponds to FIG. 4 and shows multiple key seating wear points 109 occurring with drill pipe 105 in contact with the inner wall of drilling riser 103 and other components of the underwater drilling system. It should be understood that drill pipe 105 will be rotating (as shown by the arrows in FIG. 5) in normal operation and will essentially grind away at the inside of drilling riser 103 or other components in the situation shown in FIG. 5. It also should be understood that key seating can occur at a single location in drilling riser 103 or the well, or at multiple locations along the length of drilling riser 103 or the well (or around the interior of drilling riser 103) at any given time. For example, in FIG. 5 there are four separate key seating points 109 being created. It should be understood that riser 103 (or an equivalent structure) extends through BOP stack 107 to wellhead 106. Key seating points 109 may shift depending on the parameters of the misalignment and drilling operations. For example, as the misalignment angle increases or decreases, the curve in drilling riser 103 will increase or decrease, bringing different points or point of drill pipe 105 into contact with drilling riser 103.

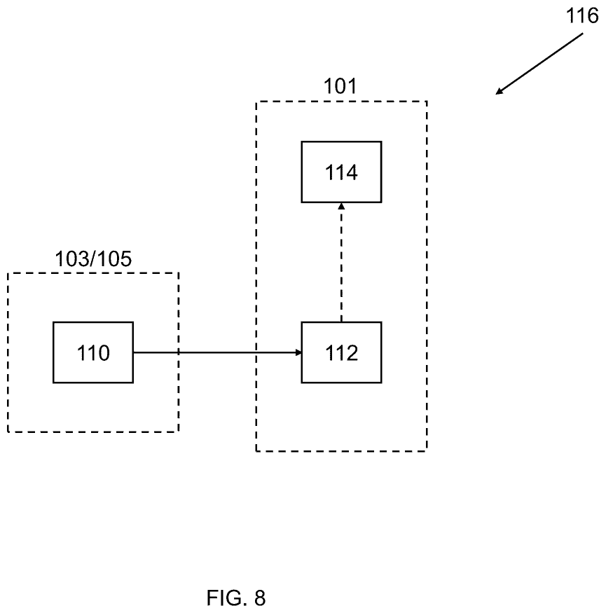

As shown in FIG. 8, components of a system 116 for detecting key seating wear include sensor 110 and controller 112. Sensor 110 is a sensor that is attached to suitable underwater structures, such as drilling riser 103 or BOP stack 107, and is configured to detect vibrational frequencies. Sensor 110 can be, for example, an accelerometer or acoustic sensor (e.g., microphone) that is sensitive enough to detect the frequencies and amplitudes associated with drilling operations and key seating (or any other type of suitable sensor). For example, sensor 110 can detect frequencies from zero to twenty kilohertz. There may be more than one sensor 110 present, as shown in FIGS. 1, 2, and 5. Each sensor 110 may be placed on a different structure to improve data collection across different structures. As shown in the Figures, two sensors 110 may be present, one attached to drilling riser 103 and one attached to BOP stack 107. This arrangement can improve data collection because drilling riser 103 and BOP stack 107 are separate structures. There may be additional sensors 110 positioned at other structures.

Sensor 110 is operably connected to controller 112, which may be disposed on drill platform 101 or may be disposed in or on a suitable subsea structure such as BOP stack 107. In some embodiments, controller 112 could be located remotely from drill platform 101, such as in a remote server that is connected to drill platform 101 by a suitable data network. Controller 112 is configured to receive the readings from sensor 110 and to process the data to determine if key seating wear is present. Controller 112 can be any suitable arrangement of processors and memory needed to carry out the relevant algorithms discussed below. Controller 112 can be operably linked to alert devices that can be used to receive an alert. These devices can include, for example display elements needed to display data and alerts to a user. In some embodiments, controller 112 can be operably linked to a data network on drill platform 101, such as a wired or wireless data network. This can allow controller 112 to send and receive data and to alert users using devices via the data network. In some embodiments, controller 112 can also use the display elements or data network to transmit other data, including graphical representations of vibration data or other outputs of the algorithms discussed here.

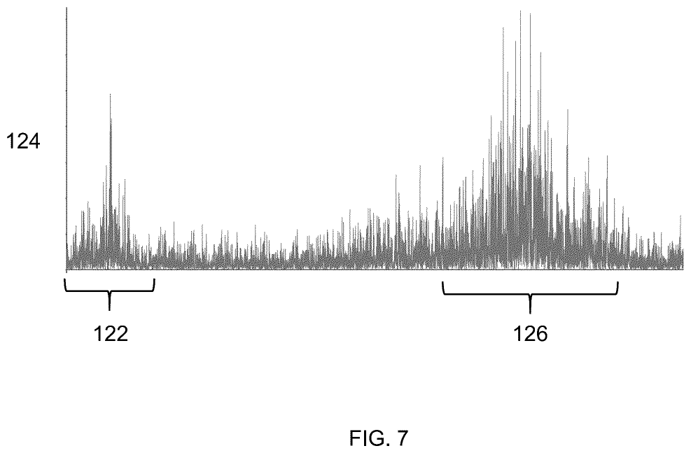

As discussed above, sensor 110 detects vibrational frequencies from one or more underwater structures (drilling riser 103 and BOP stack 107, for example). FIGS. 4 and 7 show examples of hypothetical frequency measurements recorded by sensor 110. The graph shows a frequency spectrum analysis (e.g., Fast Fourier Transform (“FFT”) or the like), where the horizontal axis represents frequency, while the vertical axis represents amplitude. In some embodiments, spectrograms may be used to show frequency and amplitude over time, e.g., to identify potential times of key seating events. Data 120 shows a data set for a drilling operation where key seating is not occurring. In data 120, there is a vibration 122 detected at certain frequencies that correspond to the ordinary machinery noise during drilling operations. Data 124 shows a hypotheticals data set that is detected during key seating. Data 124 is aligned with data 120, and there is vibration 122 present in data 124 that corresponds with the vibration 122 present in data 120. However there is an additional anomaly 126 that is present in data 122 that is not present in data 120. Anomaly 126 illustrates hypothetical sensor data that shows the presence of key seating because the physical contact between drill pipe 105 and drill riser 103 creates the noise that is being detected as anomaly 126. As will be explained in detail below, detecting key seating via sensor 110 is accomplished by examining the data for unknown anomalies that do not correspond to known drilling vibrational data—this may be done by a specially purposed computer. This can involve determining or identifying specific frequency ranges that correspond to key seating wear, or can involve filtering out the known vibrational data of drilling operations to leave only potential anomalies behind.

A method of detecting key seating using the system discussed above begins with obtaining data using sensor 110 or sensors 110. The data is transmitted to controller 112, which processes the recorded data. Processing the data involves application of frequency filters to separate out the expected noise (such as vibration 122), as shown in the example of data 120. In some embodiments the processing accounts for different operating states of the drilling system. For example, if controller 112 is also programmed to receive the current drilling system configuration, such as machinery that is currently in use, this data may be used to apply specific frequency filters based on the drilling system configuration. Any remaining data is then analyzed by controller 112 to determine whether it may represent key seating. This analysis may simply be confirmation that the remaining noise is outside of the expected frequency range. In other embodiments, the remaining noise may be compared to known examples of key seating data to determine if there is sufficient overlap between the recorded data and known key seating data to warrant a key seating alert. Controller 112 will then alert a user that key seating is suspected. As discussed above, controller 112 may use displays to alert the user, and/or transmit the alert using a data network. The user can then determine what action to take, such as pausing drilling operations while drill platform 101 is repositioned.

In some embodiments, it can be desirable to record data using sensor 110 of ordinary drilling operations where key seating is not suspected to have a baseline to compare sensor readings to in controller 112. This can be accomplished by recording data from sensor 110 using controller 112 when, for example, the misalignment angle of drilling riser 103 is known to be very low. In general, key seating is rare when misalignment is less than half of a degree (from zero degrees to half a degree of misalignment). Misalignment values over one and a half degree correspond to increasing chances of key seating, with values over two degrees corresponding to high chances of key seating. The baseline data can be stored and used to help filter any newly-recorded data for anomalies by comparison. In some embodiments, this process can be accomplished using machine learning. In these embodiments, baseline data can be processed using machine learning techniques to develop the algorithm that identifies anomalies that show key seating wear is occurring. For example, so-called training data that shows key seating wear occurring in various situations and operational configurations can be compiled with data that does not show key seating wear occurring. This data is identified and analyzed by the machine learning technique to develop an algorithm that can be used for new, unidentified data to determine if key seating wear is occurring.

In a further embodiment, the system described above includes an additional component: a signal generator 114. Signal generator 114 is located on drill platform 101 and is configured to transmit or inject a known signal into drill pipe 105. Signal generator 114 generates a signal that is synchronized to a certain time. In some embodiments, signal generator 114 is controlled by controller 112, as shown in FIG. 8. This signal is any recognizable signal that can be induced in drill pipe 105 by suitable equipment, such as an acoustic transducer or other similar systems. For example, the signal may be a sinusoidal signal. The signal induced in drill pipe 105 is set at a frequency that is substantially higher than the frequencies that are typically detected during normal drilling operations. For example, the signal may have a frequency of greater than 1000 hertz. Because drill pipe 105 is a solid material, the signal is conducted throughout drill pipe 105 at a known speed. As would be understood, both drilling riser 103 and drill pipe 105 may be hollow structures (such as tubes), but they are still formed from a solid material (such as steel or other metals/alloys).

In this embodiment, when drill pipe 105 contacts drilling riser 103 in a key seating situation, the physical contact (key seating) between these structures allows the generated signal in drill pipe 105 to be transferred to drilling riser 103. This signal can be detected by sensor 110, which along with controller 112 operates in the same manner discussed above to detect key seating and alert a user.

This embodiment has the advantage of having a known signal to detect when analyzing data from sensor 110. Because the signal is set at a high, known frequency, it can be detected more easily by controller 112 during processing. This also reduces the reliance on filtering out the known baseline noise, and improves detection of key seating because the high frequency signal is less likely to be obscured by other noise in the data.

The use of signal generator 114 also allows for the determination of where the key seating is occurring along the length of drilling riser 103 or other undersea structures. This is useful for maintenance and tracking purposes because potential damage to drilling riser 103 or other undersea structures can be tracked if the position of the key seating is known. The signal that signal generator 114 injects into drill pipe 105 has a known frequency and frequency phase set by controller 112. The physical position of sensor 110 is also known with reference to fixed element such as BOP stack 107 because sensor 110 is fixed to various structures at a known distance during drill system assembly. Because the frequency and timing of the signal is known, the timing delay between signal injection and reception can be determined by comparing when sensor 110 detects the signal versus the known signal parameters. As an example, the injected signal may be a periodically repeating signal that has a known frequency of transmission. This frequency may be such that the signal is transmitted at a known set of times, such as at the start of every second for one second with a second pause between signals. When sensor 110 detects the signal, some time will have passed because the signal travel is not instantaneous. The speed that the signal travels through drill pipe 105 and drilling riser 103 (and other undersea structures, if applicable) is a known variable based on the materials of these structures, and thus the distance to the key seating can be determined by controller 112 by using the timing delay and known travel speed. Thus, in the above example, if the signal is transmitted at the start of every second of a clock, and sensor 110 receives the signal at 1.2 seconds per the same clock, then the signal took 0.2 seconds to reach the sensor, which then can be used with the known speed to determine the distance.

A method of operation according to this embodiment begins with injecting a signal into drill pipe 105 using signal generator 114, which is controlled by controller 112. Next, sensor 110 records data. The data is transmitted to controller 112, which processes the recorded data to determine if the signal is present. As discussed above, because the frequency of the signal is known, simple frequency filtering can be used to determine the presence of the signal. Controller 112 will then alert a user that key seating wear is suspected. As discussed above, controller 112 may use alert devices, such as displays, to alert the user, and/or transmit the alert using a data network. The user can then determine what action to take, such as pausing drilling operations while drill platform 101 is repositioned. Repositioning can be accomplished using the engines and thrusters of drill platform 101. This process is often automated whereby the repositioning system is continuously working to center drill platform 101 at the specified setpoint. In some embodiments, controller 112 may automatically command repositioning system to correct the position of drill platform 101. In this embodiment, controller 112 can also determine where the key seating has occurred by comparing the known signal injection time to the detected signal time and calculating the distance based on that time delay.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way. Moreover, the examples described above do not limit the present disclosure to what has been particularly shown and described hereinabove. Rather, the scope of the present disclosure includes both combinations and sub-combinations of the various features described hereinabove, as well as variations and modifications thereof which would occur to persons skilled in the art upon reading the foregoing description and which are not disclosed in the prior art.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance. Various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

The breadth and scope of the present invention should not be limited by any of the above-described exemplary embodiments, but should be defined only in accordance with the following claims and their equivalents.

What is claimed is:

1. A system for detecting key seating wear during drilling operations, comprising:
a sensor configured to detect vibrations in an underwater drilling structure; and
a controller operably connected to the sensor, the controller configured to receive data from the sensor and to process the data to detect key seating wear.

2. The system of claim 1, wherein the sensor is one of a plurality of sensors, each of the plurality of sensors being configured to detect vibrations in an underwater drilling structure and operably connected to the controller.

3. The system of claim 1, wherein the controller is configured to send an alert to a user when key seating wear is detected.

4. The system of claim 3, further comprising a display operably connected to the controller, the controller being configured to use the display to alert the user to key seating wear.

5. The system of claim 1, the controller configured to use the sensor to record a baseline data set when key seating wear is not present.

6. The system of claim 5, the controller configured to use the baseline data to determine if key seating wear is detected.

7. The system of claim 1, wherein the underwater drilling structure is selected from the group consisting of a drilling riser and a lower marine riser package.

8. The system of claim 1, further comprising a signal injector controlled by the controller and configured to transmit a vibrational signal into a drill pipe.

9. The system of claim 8, the controller configured to detect the vibrational signal using the sensor to detect key seating wear.

10. The system of claim 9, the controller configured to determine a position of the key seating by comparing the time of injection of the signal with the time of detection of the signal by the sensor.

11. An offshore drilling system, comprising:
a drill platform; and
the system for detecting key seating wear of claim 1.

12. A method for detecting key seating wear in drilling operations, comprising:
recording vibration data in an underwater structure during drilling operations using a sensor disposed on the underwater structure;
processing the vibration data from the sensor at a controller operably connected to the sensors to detect key seating wear by filtering the data to detect an anomaly that corresponds to key seating wear.

13. The method of claim 12, wherein recording vibration data further comprises receiving data from a plurality of sensors, each of the plurality of sensors being configured to detect vibrations in an underwater drilling structure and operably connected to the controller.

14. The method of claim 12, further comprising using a display operably connected to the controller to alert a user to key seating wear.

15. The method of claim 12, further comprising using the sensor to record a baseline data set when key seating wear is not present.

16. The method of claim 15, further comprising using the baseline data as part of the processing the vibration data to determine if key seating wear is detected.

17. The method of claim 12, further comprising using a signal injector controlled by the controller to inject a vibrational signal into a drill pipe.

18. The method of claim 17, further comprising detecting the vibrational signal using the sensor.

19. The method of claim 18, determining a position of the key seating wear by comparing the detected vibrational signal to the signal injected by the signal injector.

20. A key seating detector for offshore drilling, comprising:
a sensor configured to detect vibrations in an underwater drilling structure; and
a controller disposed on a drill platform and operably connected to the sensor, the controller configured to receive data from the sensor and to process the data to detect key seating wear, and
an alert device operably connected to the controller, the controller being configured to use the alert device to alert a user to key seating wear.

21. The key seating wear detector of claim 20, wherein the alert device comprises a display.
